(19) United States
(12) Patent Application Publication
(10) Pub. No.: US 2017/0208405 A1
(43) Pub. Date: Jul. 20, 2017

(54) PROGRAMMABLE DIGITAL SOUND REPRODUCTION NETWORK

(71) Applicant: THOMAS GESSLER, Berlin (DE)

(72) Inventor: THOMAS GESSLER, Berlin (DE)

(21) Appl. No.: 15/323,049

(22) PCT Filed: Jun. 10, 2015
(86) PCT No.: PCT/EP2015/062911

§ 371 Date: Mar. 9, 2017

(30) Foreign Application Priority Data
Jul. 1, 2014 (DE) 10 2014 109 226.0

(51) Int. Cl. H04R 27/00; H04R 1/28

(52) U.S. Cl. CPC H04R 27/00; H04R 1/2803; H04R 2227/003; H04R 2201/028

(57) ABSTRACT

The invention relates to a programmable digital sound reproduction system (10), comprising a controller (12) and a plurality of active loudspeaker chassis (14) connected to the controller (12) for communication purposes, wherein the controller (12) has an interface (16) for receiving digital sound data (18) from a sound source (20), a sound data processing unit (22) for processing the digital sound data (18) to produce at least one piece of digital sound information (24), and a distributor (26) for distributing the digital sound information (24) to an active loudspeaker chassis (14), connected to the controller (12) for communication purposes, from the plurality of active loudspeaker chassis (14), the plurality of active loudspeaker chassis (14) each have a receiver (28) for receiving the corresponding digital sound information (24) distributed by the controller (12) to an active loudspeaker chassis (14) from the plurality of active loudspeaker chassis (14), an amplifier (30) for amplifying and forwarding the digital sound information (24), and a sound transducer (32) for converting the digital sound information (24) into alternating sound pressures (34). In accordance with the invention, a program-controlled signal processor (36) for specific processing of the received digital sound information (24) is arranged in each active loudspeaker chassis (14) from the plurality of active loudspeaker chassis (14). In this way, a programmable digital sound reproduction system (10) is described with which a high sound quality is made possible.

The invention relates to a programmable digital sound reproduction system for specific processing of sound information.

The processing of sound information in digital sound reproduction systems is well known from practice. A sound reproduction system generally comprises a controller with a receiver for receiving sound information. The controller also normally comprises a plurality of modules for processing the sound information. By way of example, the sound information is divided in a module into different bandwidths, and the frequency responses of the corresponding sound information are optimised in an equaliser. The processed sound information is then transmitted to an amplifier. Starting from the amplifier, the processed sound information is forwarded to a loudspeaker for conversion of the processed sound information into alternating sound pressures.

Sound reproduction systems of this type, however, have the disadvantage that the processed sound information experiences further transmission losses due to the transmission to the various modules, until the sound information is ultimately converted in the loudspeaker into alternating sound pressures, and therefore the sound quality can be adversely affected. In addition, in a system of this type, only corrections relating to the sound information itself are made. It is not possible to make a system-related correction of the sound information or an individual correction of the sound information in order to take into consideration the environment of the loudspeaker.

A digital audio distribution system is known from US 2007/0223722 A1. The audio distribution system comprises a master mixer device and an active loudspeaker unit connected via a network cable to the master mixer device. The active loudspeaker unit has a digital audio receiver for receiving digital audio signals. The digital audio signals are forwarded to a digital signal processor. A digital speech channel and a digital music channel are merged by means of the digital signal processor and are split into frequency components. The split frequency components are then forwarded via a digital amplifier to one or more sound transducers and are converted into sound. The digital audio receiver, the digital signal processor, and the digital amplifier are arranged here in a loudspeaker housing, wherein the digital amplifier forwards the frequency components to the sound transducer installed in the loudspeaker housing.

The object of the invention is to describe a programmable digital sound reproduction system with which a high sound quality can be obtained.

The object is achieved by the subject matter of claim 1. Further preferred variants are described in the dependent claims.

In accordance with the invention, a programmable digital sound reproduction systems is thus provided, comprising a controller and a plurality of active loudspeaker chassis connected to the controller for communication purposes, wherein
the controller has an interface for receiving digital sound data from a sound source, a sound data processing unit for processing the digital sound data to produce at least one piece of digital sound information, and a distributor for distributing the digital sound information to an active loudspeaker chassis, which is connected to the controller for communication purposes, from the plurality of active loudspeaker chassis,
the plurality of active loudspeaker chassis each have a receiver for receiving the corresponding digital sound information distributed by the controller to an active loudspeaker chassis from the plurality of active loudspeaker chassis, an amplifier for amplifying and forwarding the digital sound information, and a sound transducer for converting the digital sound information into alternating sound pressures,
wherein a program-controlled signal processor for specific processing of the received digital sound information is arranged in each active loudspeaker chassis from the plurality of active loudspeaker chassis.

An active loudspeaker chassis is understood in the present case to mean a loudspeaker which can be inserted and/or installed in a loudspeaker box or in a loudspeaker housing and which has a sound transducer and an immovable part holding the sound transducer, wherein the loudspeaker is made “active” in that, in addition to a conventional chassis, it also has at least one receiver, an amplifier, and a program-controlled signal processor. In the present case, the term “loudspeaker chassis” is therefore not understood to mean the housing of a loudspeaker box, but instead the actual loudspeaker with its movable part, which forms the actual sound transducer, and its immovable part, which holds the sound transducer. Here, the receiver, the amplifier, and the program-controlled signal processor are preferably secured to the immovable part of the loudspeaker.

A sound source is understood in the present case to mean any system or medium for providing digital sound data. A sound source is preferably a streaming service, a server system, a storage medium, a computer system, a Blu-ray player system, a DVD player system, or a CD player system.

The sound data processing unit processes the digital sound data into individual pieces of digital sound information. One or more modules is/are provided in the sound data processing unit for this purpose. The sound data processing unit preferably comprises a decoder, so as to be able to process sound data in different file formats (for example MP3 or FLAC) or from different multi-channel systems (for example Dolby or DTS). Furthermore, a volume management system and/or an equaliser management system are/is provided, so as to divide the sound data into different pieces of digital sound information by various filter methods depending on the bandwidth and/or depending on the frequency. In addition, the digital sound data can be equalised and/or intentionally distorted (pre-correction) and divided into various pieces of digital sound information.

In the present case, a specific processing of the digital sound information is understood to mean a system-related and/or design-related individual correction of the digital sound information and/or digital sound information adapted to the ambient conditions of the active loudspeaker chassis. The specific processing of the digital sound information is preferably a correction of the digital sound information in order to limit the bandwidth and/or in order to correct distortions and/or in order to correct quality losses. The specific processing of the digital sound information particularly preferably comprises a correction for adaptation of the sound information to the ambient conditions of the active loudspeaker chassis.

It goes without saying that the digital sound information is converted directly from the sound transducer via a digital-analog converter or in the sound transducer from digital data into analog signals and then into alternating sound pressures via the sound transducer.

It is therefore a key aspect of the invention that a program-controlled signal processor for specific processing of the received digital sound information is arranged in each active loudspeaker chassis from the plurality of active loudspeaker chassis connected to the controller for communication purposes. In this way, the particular sound information transmitted to the loudspeaker chassis can be corrected within the active loudspeaker chassis prior to the conversion into alternating sound pressures. An individual correction of the sound information can be made in each active loudspeaker chassis via the program-controlled signal processor, depending on the system-related and/or design-related and/or environment-related property of the active loudspeaker chassis.

A further preferred development of the invention makes provision so that the program-controlled signal processor is disposed between the amplifier and the sound transducer. In this way, the specific processing of the received digital sound information can be performed directly before the conversion of the digital sound information into alternating sound pressures. In this way, the sound quality of the output signal in the form of the alternating sound pressures can be increased.

In accordance with a further preferred development of the invention, provision is made so that the amplifier is an integral part of the sound transducer. In this way, the power profile of the amplifier can be matched to the specific power demand of the sound transducer. Furthermore, electrically and/or mechanically related losses as well as passive losses between the amplifier and sound transducer can be reduced by reducing loss sources in the form of long cable distances and/or connection systems, such as plugs, pole terminals, relays, coils, capacitors or resistors, due to the integral construction. In this way, the losses can be reduced and the scope minimised to specific processing of the sound information, whereby the sound quality of the output signal in the form of the alternating sound pressures can be improved.

A further preferred development of the invention lies in the fact that
a passive loudspeaker chassis is connected for communication purposes to an active loudspeaker chassis from the plurality of active loudspeaker chassis,
the sound transducer in the active loudspeaker chassis is a first sound transducer, and a second sound transducer is arranged in the passive loudspeaker chassis,
the specific processing of the received digital sound information comprises a division of the digital sound information for the first sound transducer and for the second sound transducer, and
the active loudspeaker chassis emits the alternating sound pressures generated by the first sound transducer, and the passive loudspeaker chassis emits the alternating sound pressures generated by the second sound transducer.

In this way, the digital sound information is divided for the first sound transducer and the second sound transducer during the course of the specific processing of the digital sound information via the program-controlled signal processor and is transmitted accordingly to the first sound transducer and to the second sound transducer for conversion into the alternating sound pressures. The alternating sound pressures generated by the first sound transducer are emitted via the active loudspeaker chassis, and the alternating sound pressures generated by the second sound transducer are emitted via the passive loudspeaker chassis. The active loudspeaker chassis and the passive loudspeaker chassis are thus designed to emit the alternating sound pressures. The passive loudspeaker chassis can thus preferably have small dimensions. The active loudspeaker chassis is particularly preferably a midrange speaker, and the passive loudspeaker chassis is particularly preferably a tweeter.

Alternatively, a further preferred development of the invention makes provision so that
a passive loudspeaker chassis is connected to an active loudspeaker chassis from the plurality of active loudspeaker chassis for communication purposes,
the active loudspeaker chassis from the plurality of active loudspeaker chassis comprises a first system and a second system, wherein
the first system and the second system each comprise a receiver, an amplifier, a program-controlled signal processor, and a sound transducer, wherein
the sound transducer of the second system is arranged in the passive loudspeaker chassis,
the sound data processing unit processes the digital sound data to produce a plurality of pieces of digital sound information,
the first system and the second system each receive digital sound information from the plurality of pieces of digital sound information, and
the active loudspeaker chassis emits the alternating sound pressures generated by the sound transducer of the first system, and the passive loudspeaker chassis emits the alternating sound pressures generated by the sound transducer of the second system.

In this way, a processing of the digital sound information which takes into consideration the emission of the digital sound information by means of the active loudspeaker chassis or the passive loudspeaker chassis can take place in the sound data processing unit in the controller. If the active loudspeaker chassis is a midrange speaker and the passive loudspeaker chassis is a tweeter, the digital sound information can be divided in the sound data processing unit in a manner oriented towards the frequency range of the midrange speaker and the tweeter respectively. The digital sound information can then be specifically processed subsequently by means of the program-controlled signal processor within the active loudspeaker chassis. In this way, the sound quality of the programmable digital sound reproduction system can be improved.

By means of the program-controlled signal processor in each active loudspeaker chassis, an individual specific processing of the sound information can be performed. For this purpose, ambient parameters of the respective active loudspeaker chassis and/or system-related parameters of the respective active loudspeaker chassis can be taken into consideration, so as to correct the sound information depending on these parameters. A further preferred development of the invention makes provision so that at least one sensor for capturing internal parameters and/or external parameters is connected to an active loudspeaker chassis from the plurality of active loudspeaker chassis for communication purposes.

In the present case, the internal parameters are understood to mean system-related and/or operation-related and/or age-related processes of change of an active loudspeakers chassis. Such processes of change are for example temperature drift of electronics and/or changes to the voice coil and/or changes to the diaphragm deflection and/or changes to the diaphragm acceleration and/or the resilience of the diaphragm mounting.

External parameters preferably relate to the environment of the respective active loudspeaker chassis. These are particularly preferably the ambient temperature and/or the ambient noise and/or the moisture in the region of the active loudspeaker chassis.

Based on the internal parameters and/or external parameters captured by the at least one sensor, the sound information is actively corrected by means of the program-controlled signal processor. The individual capture of internal parameters and/or external parameters for each active loudspeaker chassis from the plurality of active loudspeaker chassis, connected to the controller for communication purposes, of the programmable digital sound reproduction system enables the active individual correction of the corresponding sound information depending on changing internal parameters and/or external parameters. In this way, the sound quality of the sound output signal in the form of the alternating sound pressures can be actively adapted and thus improved.

It goes without saying that the internal parameters and/or external parameters captured by the sensor (generally in analog) are converted by means of an analog/digital converter (A/D converter), such that the program-controlled signal processor can process the captured internal parameters and/or external parameters for specific processing of the sound information.

A further preferred development of the invention lies in the fact that a data memory is arranged inside the corresponding active loudspeaker chassis from the plurality of active loudspeaker chassis. The corresponding data memory of an active loudspeaker chassis from the plurality of active loudspeaker chassis serves preferably for the storage of predefined sound information, preferably announcement texts and/or warning messages.

In conjunction with the capture of external parameters, a predefined piece of sound information can preferably be called up from the data memory by the digital signal processor and can be converted by means of the sound transducer into alternating sound pressures.

In accordance with a further preferred development of the invention, provision is made so that the connection for communication purposes between the controller and the plurality of active loudspeaker chassis is a BUS connection. The BUS connection preferably has a plurality of connection channels, wherein in each case at least one connection channel leads to a respective one of the active loudspeaker chassis. The sound information in this way can be transmitted either electrically, optically or wirelessly to at least one active loudspeaker chassis connected to the controller.

A preferred development of the invention lies in the fact that the BUS connection has a plurality of connection channels, wherein at least one first connection channel and a second connection channel lead to an active loudspeaker chassis. The first connection channel is preferably a connection channel for transmitting digital sound information between the controller and the active loudspeaker chassis, and the second connection channel is a further connection channel for transmitting digital sound information between the controller and the active loudspeaker chassis, or the second connection channel is a return channel for communication between the active loudspeaker and the controller.

If the second connection channel is a return channel, communication can take place between the active loudspeaker chassis and the controller. In this way, a bidirectional communication between the active loudspeaker chassis and the controller is made possible. Information regarding the type of a particular active loudspeaker chassis can preferably be transmitted to the controller by means of the return channel. In this way, the controller receives information regarding the active loudspeaker chassis, such that the digital sound information for the corresponding active loudspeaker chassis connected to the controller can be individually prepared in the sound data processing unit of the controller and can be transmitted to the active loudspeaker chassis. The networking between controller and active loudspeaker chassis by means of the BUS connection thus enables a specific processing of the digital sound information oriented towards the corresponding active loudspeaker chassis and can thus lead to an improved sound quality of the programmable digital sound reproduction system.

In a preferred development of the invention, provision is made so that, with a plurality of connection channels of the BUS connection, a communication between the controller and the active loudspeaker chassis can be transmitted bidirectionally and/or can be processed synchronously. Digital sound information regarding the first connection channel can thus preferably be transmitted via the first connection channel to the active loudspeaker chassis, and at the same time information can be transmitted from the active loudspeaker chassis to the controller via the second connection channel. In this way, information relating to the correction of the sound information can be forwarded to the controller directly and without delays. Due to a synchronous processing of the information arriving at the controller, in addition to a correction of the digital sound information, the incoming information can be directly taken into consideration in the correction of the digital sound information, whereby the sound quality can be directly improved or can be directly adapted to changing boundary conditions and/or ambient conditions.

The communication between the active loudspeaker chassis and the controller is particularly preferably a continuous connection. A continuous connection is understood to mean a permanently on-going connection with routine interruptions or completely without interruptions. In the event of an interruption of this continuous connection, the controller receives the information regarding the outage of the active loudspeaker chassis, such that the outage of the active loudspeaker chassis can be responded to in the sound processing unit, and the processing of the digital sound data can be adapted to the outage of the active loudspeaker chassis. The sound information is preferably forwarded to further active loudspeaker chassis connected to the controller. In the event of the outage of an active loudspeaker chassis, the networking between controller and active loudspeaker chassis by means of the BUS connection enables an improved sound quality.

Furthermore, a preferred development of the invention makes provision so that the controller and the plurality of active loudspeaker chassis have a power supply. In this way, the controller and the plurality of the active loudspeaker chassis are supplied with electrical power.

In this regard, a preferred development of the invention makes provision so that the power supply is an external network part or an accumulator. If the power supply is an accumulator, the programmable digital sound reproduction system can be used at various locations, preferably at locations at which there is no power supply available.

A further preferred development makes provision so that the power supply of an active loudspeaker chassis from the plurality of active loudspeaker chassis is matched to the corresponding specific power demand of an active loudspeaker chassis. In this way, the power demand of the active loudspeaker chassis and therefore of the entire programmable digital sound reproduction system can be reduced.

Lastly, a further preferred development of the invention makes provision so that the controller has an operator interface for operating and/or controlling the controller and/or the active loudspeaker chassis from the plurality of active loudspeaker chassis. In this way, the plurality of active loudspeaker chassis can be individually adjusted and programmed via the operator interface.

The invention additionally relates to the use of a programmable active loudspeaker chassis for the specific processing of sound information of a programmable digital sound reproduction system, wherein
the programmable digital sound reproduction system has a controller and a plurality of active loudspeaker chassis connected to the controller for communication purposes,
the controller has an interface for receiving digital sound data from a sound source, a sound data processing unit for processing the digital sound data to produce at least one piece of digital sound information, and a distributor for distributing the digital sound information to at least one active loudspeaker chassis connected to the controller for communication purposes,
wherein the active loudspeaker chassis has a receiver for receiving the digital sound information, an amplifier for amplifying and forwarding the digital sound information, a sound transducer for converting the digital sound information into alternating sound pressures, and a program-controlled signal processor for the specific processing of the received digital sound information.

Preferred developments of the use according to the invention of the programmable active loudspeaker chassis for the specific processing of sound information of a programmable digital sound reproduction system are provided in analogy to the previously described preferred developments of the programmable digital sound reproduction system according to the invention.

The invention will be explained in greater detail hereinafter on the basis of preferred exemplary embodiment of the invention with reference to the drawings, in which

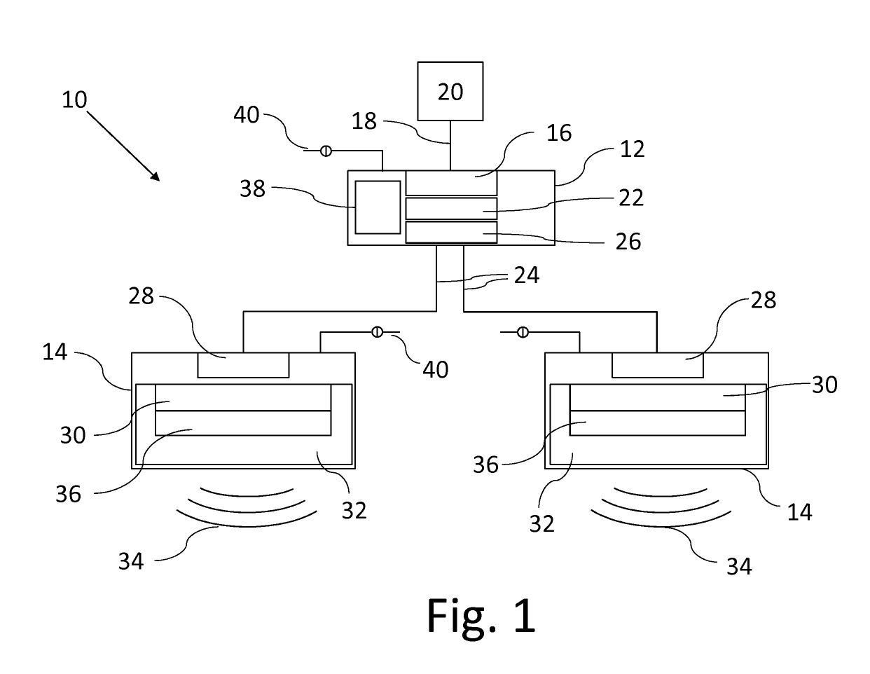

FIG. 1 shows a schematic illustration of a programmable digital sound reproduction system, comprising a controller and at least one active loudspeaker chassis connected to the controller for communication purposes in accordance with a preferred exemplary embodiment of the invention,

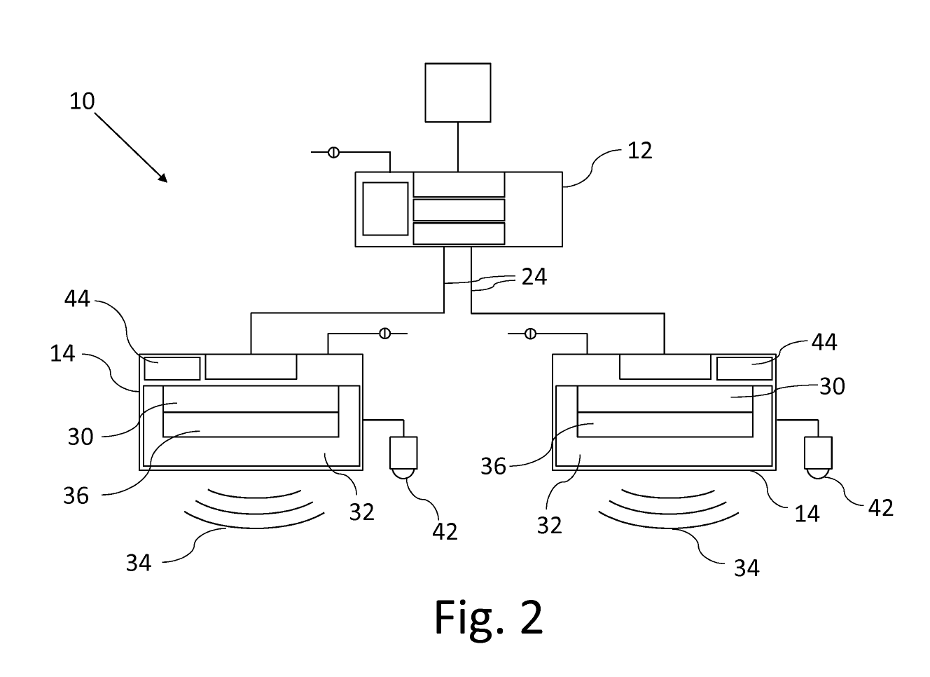

FIG. 2 shows a schematic illustration of the programmable digital sound reproduction system with a sensor for capturing external parameters of the active loudspeaker chassis connected to the controller for communication purposes in accordance with the preferred exemplary embodiment of the invention,

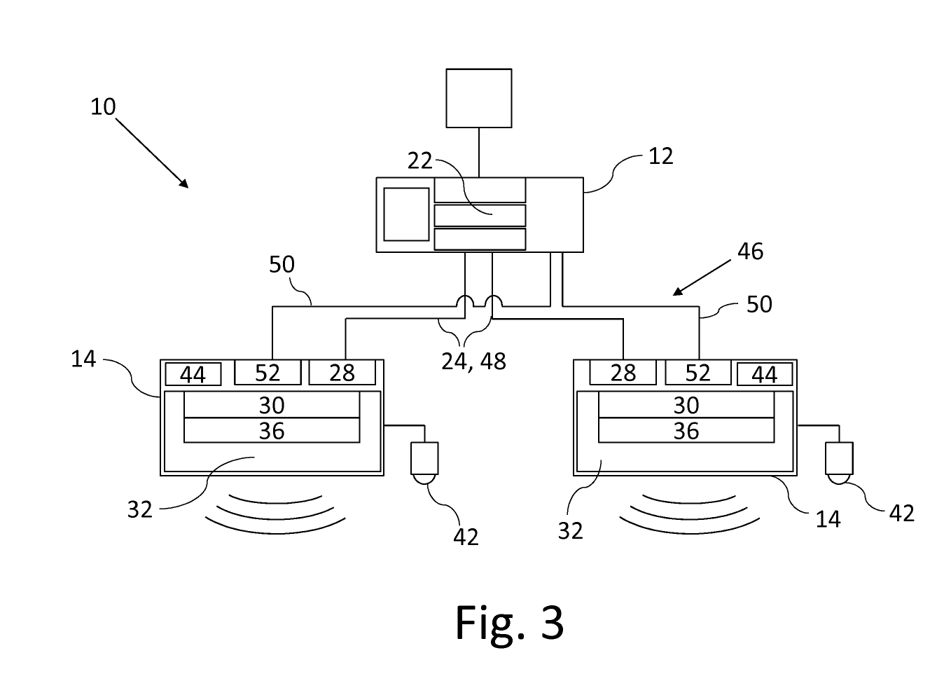

FIG. 3 shows a schematic illustration of the programmable digital sound reproduction system with a multi-channel BUS connection in accordance with the preferred exemplary embodiment of the invention, and

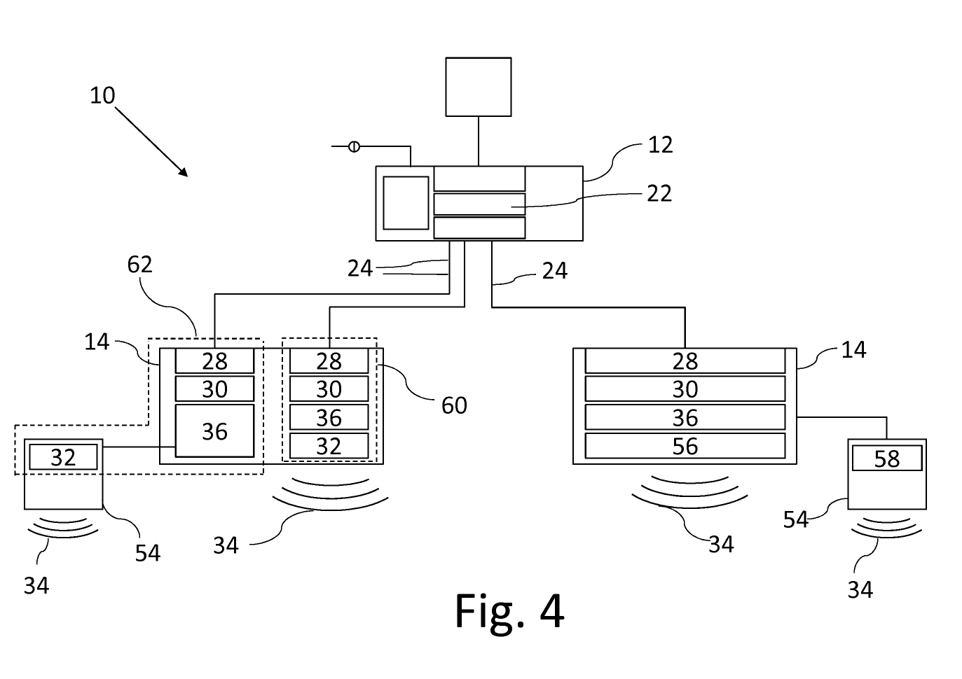

FIG. 4 shows a schematic illustration of the programmable digital sound reproduction system with a passive loudspeaker chassis connected to the active loudspeaker chassis in accordance with the preferred exemplary embodiment of the invention.

FIG. 1 shows a programmable digital sound reproduction system 10 in accordance with a preferred exemplary embodiment of the invention. The digital sound reproduction system 10 comprises a controller 12 and a plurality of active loudspeaker chassis 14 connected to the controller 12 for communication purposes.

The controller 12 has an interface 16 for receiving digital sound data 18 from a sound source 20. The controller 12 additionally comprises a sound data processing unit 22 for processing the digital sound data 18 to produce at least one piece of digital sound information 24, and a distributor 26 for distributing the digital sound information 24 to an active loudspeaker chassis 14, connected to the controller 12 for communication purposes, from the plurality of active loudspeaker chassis 14.

The plurality of active loudspeaker chassis 14 each have a receiver 28 for receiving the corresponding digital sound information 24 distributed by the controller 12 to an active loudspeaker chassis 14 of the plurality of active loudspeaker chassis 14. Furthermore, an amplifier 30 for amplifying and forwarding the digital sound information 24 and a sound transducer 32 for converting the digital sound information 24 into alternating sound pressures 34 are arranged in each loudspeaker chassis 14. It can additionally be seen that a program-controlled signal processor 36 for specific processing of the received digital sound information 24 is arranged in each active loudspeaker chassis 14 in a manner disposed between the amplifier 30 and the sound transducer 32.

In accordance with the present preferred exemplary embodiment of the invention, a sound source 20 is understood to mean any system or medium for providing digital sound data 18. A sound source 20 is preferably a streaming service, a server system, a storage medium, a computer system, a Blu-ray player system, a DVD player system, or a CD player system.

The sound processing unit 22 processes the digital sound data 18 into individual pieces of digital sound information 24. For this purpose, a module or a plurality of modules is/are provided in the sound data processing unit 22. The sound data processing unit 22 preferably comprises a decoder, so as to be able to process sound data 18 of different file formats (for example MP3 or FLAC) or from different multi-channel systems (for example Dolby or DTS). Furthermore, a volume management system and an equaliser management system are provided, so as to divide the sound data 18 into different pieces of digital sound information 24 by means of various filter methods, depending on the bandwidth and/or depending on the frequency. In addition, the digital sound data can be equalised and/or intentionally distorted (pre-correction) and divided into various pieces of digital sound information 24.

In accordance with the present preferred exemplary embodiment of the invention, a specific processing of the digital sound information 24 is understood to mean a system-related and/or design-related individual correction of the digital sound information 24 and/or to mean digital sound information 24 adapted to the ambient conditions of the active loudspeaker chassis 14. Specifically, in the present case, the processing of the digital sound information is a correction of the digital sound information in order to limit the bandwidth and/or in order to correct distortions and/or in order to correct quality losses. In addition, the specific processing of the digital sound information comprises a correction for adaptation of the sound information to the ambient conditions of the active loudspeaker chassis 14.

An individual correction of the digital sound information 24 can thus be made by means of the program-controlled signal processor 36 in each active loudspeaker chassis 14, depending on the system-related and/or design-related and/or environment-related property of the active loudspeaker chassis 14. In this way, the sound quality of the output signal in the form of the alternating sound pressures 34 can be increased.

It is also clear that the controller 12 has an operator interface 38 for operating and/or controlling the controller 12 and/or the active loudspeaker chassis 14 from the plurality of active loudspeaker chassis 14. In this way, the plurality of active loudspeaker chassis 14 can be individually adjusted and programmed by means of the operator interface 38.

The controller 12 and the plurality of active loudspeaker chassis 14 have a power supply 40. The controller 12 and a plurality of active loudspeaker chassis 14 are supplied with electrical power by means of the power supply 40. The power supply 40 can be an external network part or an accumulator.

The programmable digital sound reproduction system 10 already known from FIG. 1 is shown in FIG. 2, wherein, in the case of the programmable digital sound reproduction system 10 shown in FIG. 2, a sensor 42 for capturing external parameters is connected to each active loudspeaker chassis 14 from the plurality of active loudspeaker chassis 14 for communication purposes.

External parameters preferably concern the environment of the particular active loudspeaker chassis 14, for example in the present case the ambient temperature and/or the ambient noise and/or the moisture in the region of the active loudspeaker chassis 14.

On the basis of the external parameters captured by a sensor 42, the sound information 24 is actively corrected by means of the program-controlled signal processor 36. The individual capture of external parameters for each active loudspeaker chassis 14 from the plurality of active loudspeaker chassis 14, connected to the controller 12 for communication purposes, of the programmable digital sound reproduction system 10 enables the active individual correction of the particular sound information 24 depending on changing external parameters. In this way, the sound quality of the sound output signal in the form of the alternating sound pressures 34 can be adapted to the ambient conditions of the particular active loudspeaker chassis 14, and therefore can be improved.

A data memory 44 is also arranged in each active loudspeaker chassis 14 from the plurality of active loudspeaker chassis 14 connected to the controller 12 for communication purposes. The data memory 44 of an active loudspeaker chassis 14 from the plurality of active loudspeaker chassis 14 serves to store predefined sound information, preferably such as announcement texts and/or warning messages.

In conjunction with the capture of external parameters, a predefined piece of sound information can be called up from the data memory 44 by the digital signal processor 36 and can be converted by means of the sound transducer 32 into alternating sound pressures 34.

It can be seen from FIG. 3 that the connection, for communication purposes, between the controller 12 and the active loudspeaker chassis 14 connected to the controller 12 for communication purposes is a BUS connection. The BUS connection 46 has a first connection channel 48 and a second connection channel 50, wherein in the present case the first connection channel 48 serves for the transmission of the digital sound information 24 between the controller 12 and the corresponding active loudspeaker chassis 14, and the second connection channel 50 is a return channel for transmitting information 52 between the corresponding active loudspeaker chassis 14 and the controller 12.

The information 52 transmitted from the corresponding active loudspeakers chassis 14 to the controller 12 preferably contains details regarding the amplifier 30 and/or the sound transducer 32 of the active loudspeaker chassis 14. In this way, the digital sound information 24 for the particular active loudspeaker chassis 14 connected to the controller 12 can be prepared in the sound data processing unit 22 of the controller 12 and can be transmitted to the active loudspeaker chassis 12.

In addition to the transmission of information 52 regarding the type of active loudspeaker chassis 14, the external parameters captured by the sensor 42 of the active loudspeaker chassis 14 are additionally forwarded to the controller 12, such that the digital sound information 24 can be processed in the sound data processing unit 22 of the controller 12 on the basis of the external parameters. The digital sound information 24 is then preferably processed in the controller 12 if the specific processing of the digital sound information 24 in the active loudspeaker chassis 14 is not sufficient. This can preferably be necessary when high background noises are captured by the sensor 42 and an adaptation of the volume by means of the program-controlled signal processor 36 does not appear to be sufficient. In this case, the digital sound information is already adapted in respect of the volume in the sound data processing unit 22 of the controller 12.

In addition, the communication between the active loudspeaker chassis 14 and the controller 12 is a continuous connection. In the event of an interruption of this continuous connection, the controller 12 receives the information regarding the outage of the active loudspeaker chassis 14, such that the outage of the active loudspeaker chassis 14 can be responded to in the sound data processing unit 22 and the processing of the digital sound information 24 can be adapted to the outage of the active loudspeaker chassis 14. In this case, the digital sound information 24 is preferably transmitted to further active loudspeaker chassis 14 connected to the controller 12.

It can be seen from FIG. 4 that a passive loudspeaker chassis 54 is connected for communication purposes to each active loudspeaker chassis 14 connected to the controller 12 for communication purposes. The particular feature of the present programmable digital sound reproduction system 10 lies in the construction of the active loudspeakers chassis 14.

In the right-hand active loudspeaker chassis 14, the sound information 24 transmitted from the controller 12 to the active loudspeaker chassis 14 is received by the receiver 28, is amplified by the amplifier 30, and is subject to specific processing by the program-controlled signal processor 36, wherein the specific processing of the sound information 24 comprises the division of the sound information 24 for the transmission to a first sound transducer 56 arranged in the active loudspeaker chassis 14 and to a second sound transducer 58 arranged in the passive loudspeaker chassis 54. Here, provision is made so that the alternating sound pressures 34 generated by the first sound transducer 56 are emitted by means of the active loudspeaker chassis 14, and the alternating sound pressures generated by the second sound transducer 58 are emitted by means of the passive loudspeaker chassis 54. In this way, a piece of sound information 24 transmitted to the active loudspeaker chassis 14 can be divided by the program-controlled signal processor 36 within the active loudspeaker chassis 14 and can be transmitted to the first sound transducer 56 and the second sound transducer 58.

In the left-hand active loudspeaker chassis 14, there is arranged a first system 60 and a second system and 62, wherein the first system 60 and the second system 62 each comprise a receiver 28, an amplifier 30, a program-controlled signal processor 36, and a sound transducer 32, wherein the sound transducer 32 of the second system 62 is arranged in the passive loudspeaker chassis 54. The alternating sound pressures 34 of the first system 60 generated by the sound transducer 32 are emitted via the active loudspeaker chassis 14 and the alternating sound pressures 34 of the second system 62 generated by the sound transducer 32 are emitted by the passive loudspeaker chassis 14. Due to the two systems, separated from one another, within the active loudspeaker chassis 14, the transmission of two pieces of digital sound information 24 is required from the controller 14 to the active loudspeaker chassis 14. In this way, a deliberate specific processing of the digital sound information 24 can be performed in each system. In addition, the digital sound information 24 can be processed already in the controller, said processing being directed to the emission of the digital sound information 24 by means of the active loudspeaker chassis 14 or the passive loudspeaker chassis 54. The sound quality of the programmable digital sound reproduction system 10 can thus be increased.

Lastly, the particular features of the programmable digital sound reproduction system will be explained again:

A specific processing of the digital sound information 24 directly by the conversion of the digital sound information 24 into alternating sound pressures can be performed with the programmable digital sound reproduction system 10, comprising the controller 12 and a plurality of active loudspeaker chassis 14 connected to the controller 12 for communication purposes.

The specific processing in this case for example provides a correction of a system-related and/or design-related limitation of the bandwidth and/or of distortions of the digital sound information 24 and/or of quality losses of the digital sound information 24 during the course of the transmission. In addition, the specific processing of the digital sound information 24 can comprise a correction for adaptation of the digital sound information 24 to the ambient conditions of the active loudspeaker chassis 14.

For the specific processing of the digital sound information 24, the program-controlled signal processor 36 is arranged in each active loudspeaker chassis 14, preferably between the amplifier 30 and the sound transducer 32.

Since the program-controlled signal processor 36 is arranged in each active loudspeaker chassis 14, an individual specific processing of the digital sound information 24 in accordance with the system-related and/or design-related properties of the active loudspeaker chassis 14 can be performed in each active loudspeaker chassis 14.

The digital sound data 18 is preferably divided into a plurality of different pieces of digital sound information 24. The digital sound information 24 is particularly preferably divided in accordance with the reproduction bandwidth of any active loudspeaker chassis 14 connected to the controller 12 and transmitted to the corresponding active loudspeaker chassis 14. In this way, a correction for the corresponding reproduction bandwidth is made in the corresponding active loudspeaker chassis 14. A quick specific correction of the digital sound information 24 can thus be attained.

Provision is also made so that, with each active loudspeaker chassis 14, one or more sensors 42 for capturing the system-related properties of the active loudspeaker chassis 14 and/or for capturing the ambient conditions of the active loudspeaker chassis 14 is/are connected to each active loudspeaker chassis 14 for communication purposes, so as to be able to selectively and actively correct the digital sound information 14 individually for each active loudspeaker chassis 14.

The BUS connection between the controller 12 and the active loudspeaker chassis 14 enables a communication from the controller 12 to the corresponding active loudspeaker chassis 14 and a communication from the corresponding active loudspeaker chassis to the controller 12. The communication between the active loudspeaker chassis and the controller enables the active provision of information regarding the active loudspeaker chassis. Besides general information regarding the components installed within the active loudspeaker chassis for processing the digital sound information in the controller, internal parameters and/or external parameters captured by the sensors for processing the digital sound information in the sound data processing unit can also be transmitted to the controller. Furthermore, outages of an active loudspeaker chassis 14 can be captured by the controller, such that the processing of the digital sound information 24 in the sound data processing unit 22 can be adapted and the digital sound information 24 can be transmitted to the further active loudspeaker chassis 14 connected to the controller 12. The networking between controller 12 and active loudspeaker chassis 14 thus enables continuously adapted and consistently high sound quality.

The sound quality for each active loudspeaker chassis 14 can thus be individually adapted and improved with the programmable digital sound reproduction system 10.

### REFERENCE SIGNS

10 programmable digital sound reproduction system
12 controller
14 active loudspeaker chassis
16 interface
18 digital sound data
20 sound source
22 sound data processing unit
24 sound information
26 distributor
28 receiver
30 amplifier
32 sound transducer
34 alternating sound pressures
36 program-controlled signal processor
38 operator interface
40 power supply
42 sensor
44 data memory
46 BUS connection
48 first connection channel
50 second connection channel (return channel)
52 information
54 passive loudspeaker chassis
56 first sound transducer
58 second sound transducer
60 first system
62 second system

1. A programmable digital sound reproduction system (10), comprising a controller (12) and a plurality of active loudspeaker chassis (14) connected to the controller (12) for communication purposes, wherein
the controller (12) has an interface (16) for receiving digital sound data (18) from a sound source (20), a sound data processing unit (22) for processing the digital sound data (18) to produce at least one piece of digital sound information (24), and a distributor (26) for distributing the digital sound information (24) to an active loudspeaker chassis (14), connected to the controller (12) for communication purposes, from the plurality of active loudspeaker chassis (14),
the plurality of active loudspeaker chassis (14) each have a receiver (28) for receiving the corresponding digital sound information (24) distributed by the controller (12) to an active loudspeaker chassis (14) from the plurality of active loudspeaker chassis (14), an amplifier (30) for amplifying and forwarding the digital sound information (24), and a sound transducer (32) for converting the digital sound information (24) into alternating sound pressures (34),
wherein a program-controlled signal processor (36) for specific processing of the received digital sound information (24) is arranged in each active loudspeaker chassis (14) from the plurality of active loudspeaker chassis (14).

2. The programmable digital sound reproduction system according to claim 1, characterised in that the program-controlled signal processor (36) is disposed between the amplifier (30) and the sound transducer (32).

3. The programmable digital sound reproduction system (10) according to claim 1, characterised in that the amplifier (30) is an integral part of the sound transducer (32).

4. The programmable digital sound reproduction system (10) according to claim 1, characterised in that
a passive loudspeaker chassis (54) is connected to an active loudspeaker chassis (14) from the plurality of active loudspeaker chassis (14) for communication purposes, the sound transducer (32) in the active loudspeaker chassis (14) is a first sound transducer (56), and a second sound transducer (58) is arranged in the passive loudspeaker chassis (54),
the specific processing of the received digital sound information (24) comprises a division of the digital sound information (24) for the first sound transducer (56) and for the second sound transducer (58), and
the active loudspeaker chassis (14) emits the alternating sound pressures (34) generated by the first sound transducer (56), and the passive loudspeaker chassis emits the alternating sound pressures generated by the second sound transducer (58).

5. The programmable digital sound reproduction system (10) according to claim 1, characterised in that
a passive loudspeaker chassis (54) is connected to an active loudspeaker chassis (14) from the plurality of active loudspeaker chassis (14) for communication purposes,
the active loudspeaker chassis (14) from the plurality of the active loudspeaker chassis (14) has a first system (60) and a second system (62), wherein
the first system (60) and the second system (62) each have a receiver (28), an amplifier (30), a program-controlled signal processor (36), and a sound transducer (32),
wherein the sound transducer (32) of the second system (62) is arranged in the passive loudspeaker chassis (54),
the sound data processing unit (22) processes the digital sound data (18) to produce a plurality of pieces of digital sound information (24),
the first system (60) and the second system (62) each receive digital sound information (24) from the plurality of pieces of digital sound information (24), and
the active loudspeaker chassis (14) emits the alternating sound pressures (34) generated by the sound transducer (32) of the first system (60), and the passive loudspeaker chassis emits the alternating sound pressures generated by the sound transducer (32) the second system (62).

6. The programmable digital sound reproduction system (10) according to claim 1, characterised in that at least one sensor (42) for capturing internal parameters and/or external parameters is connected to an active loudspeaker chassis (14) from the plurality of active loudspeaker chassis (14) for communication purposes.

7. The programmable digital sound reproduction system (10) according to claim 1, characterised in that a data memory (44) is arranged within the active loudspeaker chassis (14) of the plurality of active loudspeaker chassis (14).

8. The programmable digital reproduction system (10) according to claim 1, characterised in that the connection, for communication purposes, between the controller (12) and the plurality of active loudspeaker chassis (14) is a BUS connection.

9. The programmable digital sound reproduction system (10) according to claim 8, characterised in that the BUS connection (46) has a plurality of connection channels, wherein in each case at least one first connection channel (48) and a second connection channel (50) lead to an active loudspeaker chassis (14).

10. Use of a programmable active loudspeaker chassis (14) for specific processing of sound information (24) of a programmable digital sound reproduction system (10), wherein
the programmable digital sound reproduction system (10) has a controller (12) and a plurality of active loudspeaker chassis (14) connected to the controller (12) for communication purposes,
the controller (12) has an interface (16) for receiving digital sound data (18) from a sound source (20), a sound data processing unit (22) for processing the digital sound data (18) to produce at least one piece of digital sound information (24), and a distributor (26) for distributing the digital sound information (24) to at least one active loudspeaker chassis (14) connected to the controller (12) for communication purposes,
wherein the active loudspeaker chassis (14) has a receiver (28) for receiving the digital sound information (24), an amplifier (30) for amplifying and forwarding the digital sound information (24), a sound transducer (32) for converting the digital sound information (24) into alternating sound pressures (34), and a program-controlled signal processor (36) for specific processing of the received digital sound information (24).
